(19) United States
(12) Patent Application Publication
(10) Pub. No.: US 2009/0093217 A1
(43) Pub. Date: Apr. 9, 2009

(54) Channel measurement method and apparatus of multi-band multi-standby mobile terminal

(75) Inventor: Hwan Wook Shin, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/287,487

(22) Filed: Oct. 9, 2008

(30) Foreign Application Priority Data
Oct. 9, 2007 (KR) 2007-0101361

(51) Int. Cl. H04B 17/00

(52) U.S. Cl. 455/67.11

(57) ABSTRACT

A channel measurement method and apparatus for a Global System for Mobile Communications (GSM) terminal is provided for efficiently measuring signal strengths on all available channels of multiple mobile communication systems. The channel measurement method of the present invention includes measuring, at a first module and a second module, signal strengths on channels designated for the first and second modules; collecting the signal strengths of the channels measured by the first and second modules; and arranging the channels in an order of the signal strengths.

### CROSS-REFERENCE TO RELATED APPLICATION(S) AND CLAIM OF PRIORITY

The present application claims priority to an application entitled “CHANNEL MEASUREMENT METHOD AND APPARATUS OF MULTI-BAND MULTI-STANDBY MOBILE TERMINAL” filed in the Korean Intellectual Property Office on Oct. 9, 2007 and assigned Serial No. 2007-0101361, the contents of which are incorporated herein by reference.

### TECHNICAL FIELD OF THE INVENTION

The present invention relates to a mobile communication system and, in particular, to a channel measurement method and apparatus for a Global System for Mobile Communications (GSM) terminal that is capable of efficiently measuring signal strengths on all available channels of multiple mobile communication systems.

### BACKGROUND OF THE INVENTION

Typically, when a mobile terminal powers on, it performs an initialization procedure before its location update. The initialization procedure is composed of frequency synchronization, timing synchronization, and cell information acquisition based on receipt of broadcast control channel (BCCH).

Among them, the frequency synchronization process includes a channel measurement step for measuring received signal strengths of all available channels and a Frequency Correction Channel (FCCH) searching step for searching the FCCH.

Recently, dual Subscriber Identity Module (SIM) GSM terminals, which are available to allow holding two SIMs, are being introduced, and some dual SIM mobile terminals support dual standby mode.

Such a dual standby GSM terminal is provided with pairs of operation modules operating on two different frequency bands. That is, the dual standby GSM terminal includes a pair of core modules, a pair of power management modules, a pair of memory modules, a pair of RF modules, and a pair of SIMs that constitute two individual GSM modules. The two GSM modules can be configured to share a single control interface. This means that the two GSM modules share the display, keypad, battery, and controller of the dual standby GSM terminal. The two GSM modules communicate through a specific interface such as Dual Port Random Access Memory (DPRAM). The two GSM modules act as independent GSM terminal: one as master and the other as slave.

Typically, Primary GSM (P-GSM) uses 124 channels, Extended GSM (E-GSM) uses 174 channels, Digital Cellular System (DCS) uses 374 channels, and Personal Communication Services (PCS) uses 299 channels.

Accordingly, in a case of a dual standby GSM/DCS terminal has to measure total 548 channels in the channel measurement step. If the mobile terminal is implemented to support triple bands of GSM/DCS/PCS or quad bands of GSM/DCS/PCS/GSM850 the number of channels to be measured dramatically increases.

However, the conventional multi-band multi-standby mobile terminal has a drawback in that both the master and slave modules are performing the channel measurements on all the channels (e.g., channels in GSM/DCS terminal) in the initialization process, respectively. The initialization process is performed when the mobile terminal enters a limited service area as well as when it powers on.

Also, unlike the single standby GSM/DCS terminal having a signal RF module which measures all the channels (i.e., 548 channels), the dual standby GSM/DCS terminal is configured such that two RF modules measure all 548 channels respectively, resulting in channel measurement inefficiency and, in turn, increases of channel measurement time and power consumption.

### SUMMARY OF THE INVENTION

To address the above-discussed deficiencies of the prior art, it is a primary object to provide a channel measurement method and apparatus that enables a multi-standby mobile terminal to efficiently perform an initialization process.

Also, the present invention provides a channel measurement method and apparatus for a multi-standby mobile terminal that is capable of reducing a delay taken for measuring radio signal strengths of channels in an initialization process of the mobile terminal.

Also, the present invention provides a channel measurement method and apparatus for a multi-standby mobile terminal that enables multiple communication modules constituting the mobile terminal to be responsible for measuring equally divided numbers of channels, resulting in reduction of channel measurement time and power consumption.

In accordance with an exemplary embodiment of the present invention, a channel measurement method for a multi-band mobile terminal includes measuring, at a first module and a second module, signal strengths on channels designated for the first and second modules; collecting the signal strengths of the channels measured by the first and second modules; and arranging the channels in an order of the signal strengths.

In accordance with another exemplary embodiment of the present invention, a channel measurement method for a multi-band multi-standby mobile terminal includes designating, by a channel designator, channels for a master module and at least one slave module according to predetermined channel designation criteria; measuring, by channel measurement units of the modules, signal strengths of the channels designated by the channel designator; collecting, by a measurement collector, the signal strengths of the designated channels measured by the channel measurement units; and arranging, by a channel arrangement unit, the channels in an order of the signal strengths.

In accordance with another exemplary embodiment of the present invention, a channel measurement apparatus for a multi-band mobile terminal includes a master module for designating channels for at least one module, measuring signal strengths designated for itself, collecting the signal strengths, and arranging the channels in an order of the signal strengths; and at least one slave module for measuring signal strengths of the channel designated by the master module and transmitting the measured signal strengths to the master module.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior uses, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic block diagram illustrating a channel measurement part of a conventional multi-standby mobile;

FIG. 2 is a block diagram illustrating a channel measurement part of a mobile terminal according to an exemplary embodiment of the present invention;

FIG. 3 is a flowchart illustrating a channel measurement method for a mobile terminal according to an exemplary embodiment of the present invention; and

FIG. 4 is a block diagram illustrating a configuration of a mobile terminal according to an exemplary embodiment of the present invention.

### DETAILED DESCRIPTION OF THE INVENTION

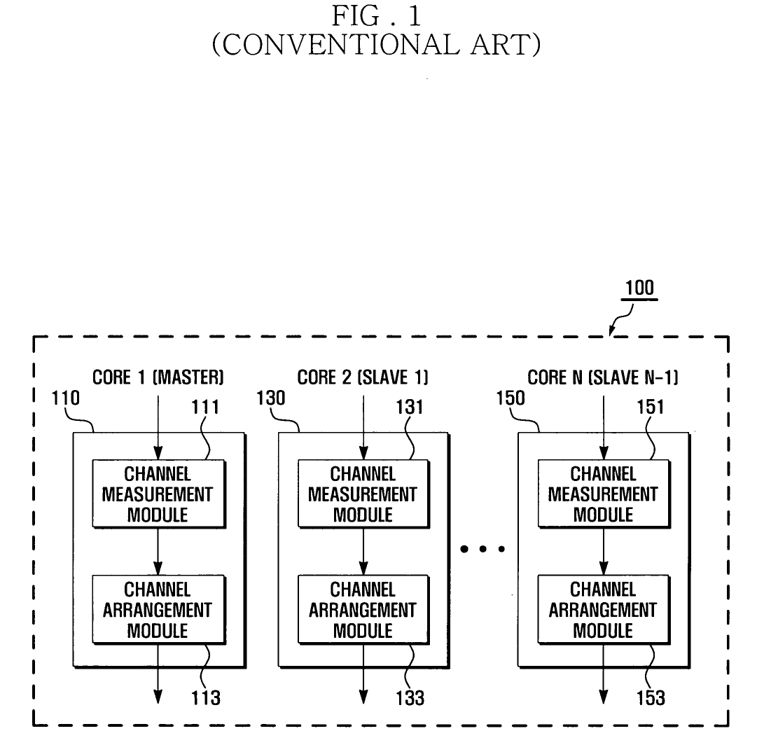

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication system.

In the following, a channel measurement method and apparatus is described in focusing on the reduction of the time taken for measuring radio frequency signal strengths of entire channels. Assuming that N is a number of GSM modules of a mobile terminal and C is a total number of channels of N GSM systems, each GSM module is responsible for measuring C/N channels, whereby the channel measurement time of the mobile terminal decreases dramatically.

FIG. 1 is a schematic block diagram illustrating a channel measurement part of a conventional multi-standby mobile.

Referring to FIG. 1, the channel measure part 100 of the mobile terminal includes at least two GSM modules including a master module 110 and at least one slave module 130 and 150. Each GSM module is composed of a channel measurement element that is provided with a channel measurement module 111 (or 131 or 151) and a channel arrangement module 113 (or 133 or 153).

The GSM modules 110, 130, and 150 of the mobile terminal have the same structure. That is, the master module 110 and the at least one slave module 130 and 150 are structured in the same configuration. In the conventional multi-standby GSM terminal, each GSM module performs channel measurement on the entire number of channels independently, whereby it takes a relatively long time to measure the entire number of channels since each channel is repeatedly measured by every GSM module.

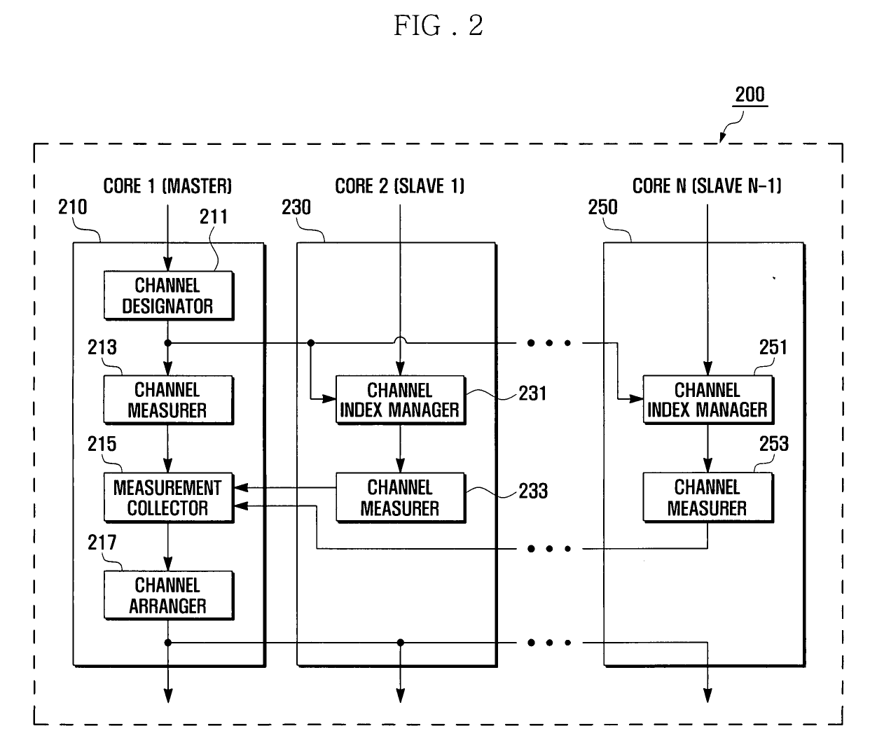

FIG. 2 is a block diagram illustrating a channel measurement part of a mobile terminal according to an exemplary embodiment of the present invention.

Referring to FIG. 2, unlike the conventional multi-standby mobile terminal which includes a master module and at least one slave module configured with the same internal structure, the multi-standby mobile terminal 200 according to this embodiment includes a master module 210 and at least one slave module (N−1 slave modules 230 and 250) configured with different internal structures.

In FIG. 2, the master module 210 includes a channel designator 211 for allocating channels to be measured for the master and N−1 slave modules (N is a natural number), a channel measurer 213 for measuring the designated channels, a measurement collector 215 for collecting the signal strengths of the channels measured by the individual channel GSM modules 210, 230, and 250, and an channel arranger 217 for arranging collected channels in an order of their signal strengths.

Each slave module 230 (or 250) includes a channel index manager 231 (or 251) for managing the channel indexes of the channels designated for the slave module 230 (or 250) and a channel measurer 233 (or 253) for measuring the designated channels.

As described above, the master module 210 is provided with the channel designator 211 for designating the channels to be measured by the GSM modules 210, 230, and 250 right before the channel measurer 213 and a measurement collector 215 interposed between the channel measurer 213 and the channel arranger 217 that are not shown in the master module 110 of the conventional multi-standby mobile terminal. Also, each of the N−1 slave modules 230 and 250 has a channel index manager 231 (251) and does not have the channel arranger unlike the conventional multi-standby mobile terminal's slave module (130 or 150) that has the channel arranger but not the channel index manager.

The operation of the above structured channel measurement part of the mobile terminal is described hereinafter in more detail. In the following, the mobile terminal is assumed to be a dual band dual standby mobile terminal supporting the GSM and DCS. That is, the dual band dual standby mobile terminal has a channel measurement part 200 composed of the master module 210 and the slave module 230.

As mentioned above, the total number of channels of the CSM and DCS systems is 548. Unlike the convention dual band dual standby mobile terminal of which master and slave modules measure the 548 channels respectively, the master and slave modules 210 and 230 of the dual band dual standby mobile terminal according to this embodiment measure only the fairly designated channels rather than all the channels. Under the assumption that the master and slave modules 210 and 230 have the same performance, the channel measurement is explained with an ideal case in that the same number of channels are designated for the respective master and slave modules 210 and 230. However, the channel designation policy can be determined depending on the various design criteria of the manufacturer such as performances of core chips and number of core chips. In this embodiment, the same number of channels is designated for the master and slave modules 210 and 230.

Accordingly, the channel designator 211 designates 274 channels for the respective master and slave modules 210 and 230. If the channels are designated, each of the master and slave modules 210 and 230 measure the signal strengths on the 274 channels designated for itself by means of the channel measurer 213 (233) and transmits the measurement values to the measurement collector 215 of the master module 210.

If the measurement values on the 548 channels, i.e. 274 channels for the master module 210 and 274 channels for the slave module 230, are collected from the channel measures 213 and 233, the channel arranger 217 arranges the 548 channels in an order of the signal strengths and transmits the arrangement result to the slave module 230 to complete the channel measurement process.

After the channel measurement is successfully performed, the master and slave modules 210 and 230 search the FCCH, perform timing synchronization, and receive BCCH, respectively so as to proceed to the cell information acquisition process.

As described above, since the master and slave modules 210 and 230 perform the signal strength measurement on the 274 channels designated themselves respectively, the channel measurement time of the dual band dual standby mobile terminal according to this embodiment decreases to one half (½) in comparison with the conventional dual band dual standby mobile terminal.

Now, a channel measure method of the dual band dual standby mobile terminal according to an exemplary embodiment of the present invention is described.

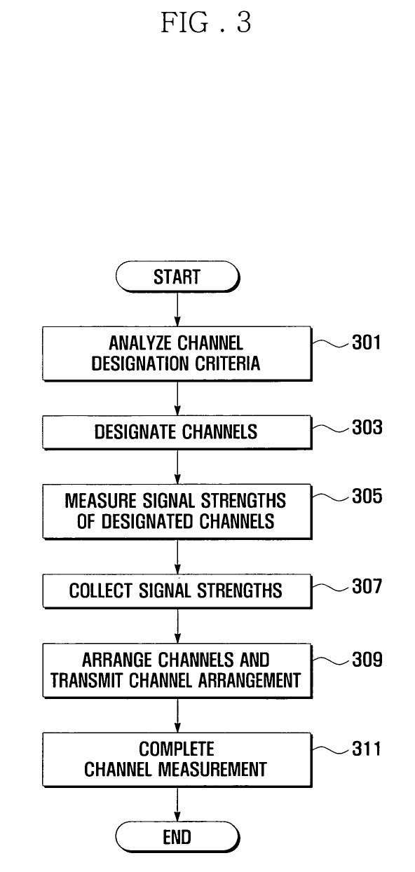

FIG. 3 is a flowchart illustrating a channel measurement method for a mobile terminal according to an exemplary embodiment of the present invention.

Referring to FIG. 3, the channel designator 211 of the master module 210 first determines a channel designation policy through the channel designation condition analysis (S301). The channel designation policy can be predetermined according to the capabilities of the master and slave modules 210 and 230 and stored within the mobile terminal. The channel designation policy can be determined according to the design criteria of the manufacturer such as the performances of the core chips and the number of the core chips. Next, the channel designator 211 designates the channels to be measured by the master and slave modules 210 and 230 (S303). In this embodiment, it is assumed that the master and slave modules 210 and 230 are designated the same number of channels.

After the channels to be measured are designated, the master and slave modules 210 and 230 measure the signal strengths of the designated channels (S305). The measurement values are collected by the measurement collector 215 of the master module 210.

The measurement collector 215 of the master module 210 collects the measurement values (S307). Next, the measurement collector 215 arranges the channels in an order of the signal strengths and transmits the arrangement result to the slave module 230 (S309), whereby the channel measurement procedure is completed (S311).

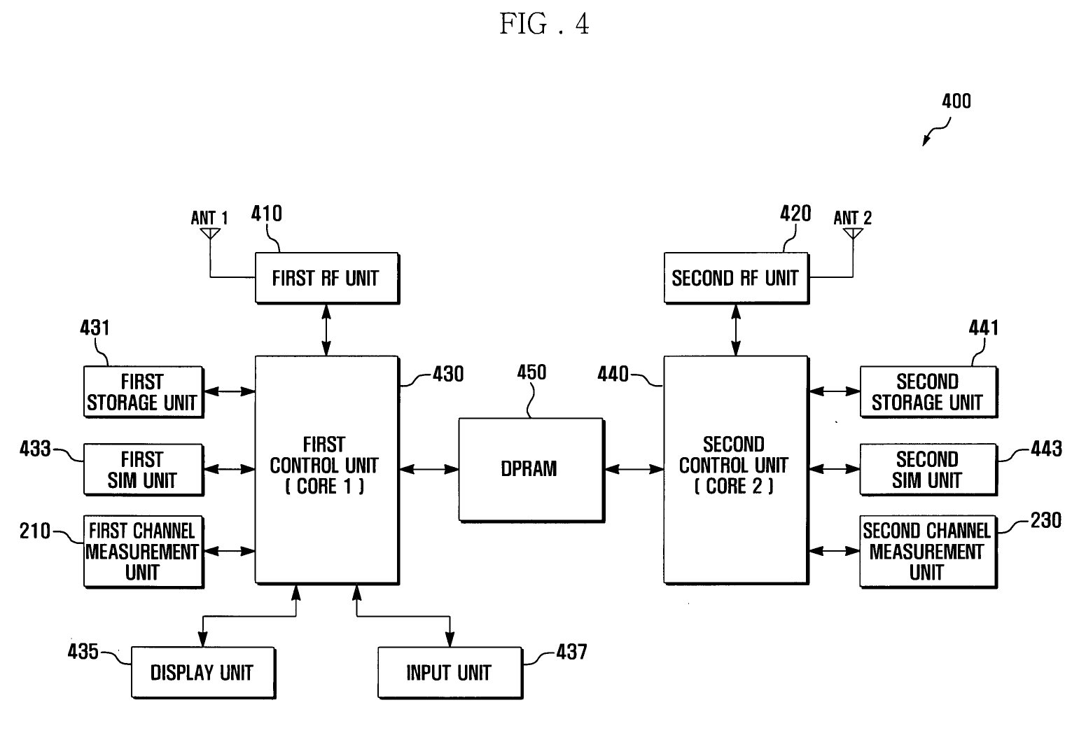

FIG. 4 is a block diagram illustrating a configuration of a mobile terminal according to an exemplary embodiment of the present invention. In FIG. 4, the mobile terminal is depicted as a dual band dual standby mobile terminal. However, the mobile terminal can be implemented as a multi-band multi-standby mobile terminal equipped with more than two different communication system modules.

Referring to FIG. 4, the dual band dual standby mobile terminal 400 according to this embodiment of the present invention includes two GSM modules. The first GSM module as a master module includes a first RF unit 410, a first control unit 430, a first storage unit 431, a first SIM unit 433, a first channel measurement unit 210, a display unit 435, and input unit 437. The second GSM module as a slave module includes a second RF unit 420, a second control unit 440, a second storage unit 441, a second SIM unit 443, and a second channel measurement unit 230.

The first and second GSM modules are interconnected via a DPRAM 450 which supports the inter-process communication.

The first and second RF units 410 and 420 are responsible for radio communications of the mobile terminal 400 using respective communication protocols. Each of the first and second RF unit 410 and 420 is provided with an RF transmitter for up-converting and amplifying the transmission signal, an RF receiver for low noise amplifying and down-converting the received signal, and a duplexer for separating the transmission and reception paths of the signals transmitted and received through an antenna (ANT1 or ANT2).

Each of the first and second control units 430 and 440 is provided with a modem, a codec, and a data processor. The codec may include a data codec for processing packet data and an audio codec for processing audio data including voice. The first and second RF units 410 and 420 perform coding and modulation on the transmission signal and demodulation and decoding on the received signal. Here, the data processor can be implemented in separation with first and second control units 430 and 440.

Particularly in this embodiment, the first control unit 430 designates the channels to be measured by the first and second GSM modules, controls such that the first and second GSM modules measure the designated channels, collects the signal strength values measured by the first and second GSM modules, and arranges the channels in an order of the signal strengths. The second control unit 440 controls such that the second channel measurement unit 230 measures the channels with reference to the channel indexes designated by the first control unit 430.

The first control unit 430, as the master unit, controls general operations of the mobile terminal. Although the first control unit 430 is configured as the master unit, the second control unit 440 can be configured as the master unit.

The DPRAM 450 acts as a communication interface between the first and second control units 430 and 440.

Each of the first and second SIM units 433 and 443 is provided with a SIM card containing subscriber information and user data saved by the user and a connection interface to the control unit 430 (440). The SIM card can be detachably installed to the SIM unit 433 (443) in connection with the connection interface.

The first and second channel measurement units 210 and 230 operate as described with reference to FIG. 2. Particularly in this embodiment, the first channel measurement unit 210 is provided with a channel designator 211 for designating the channels with channel indexes for the individual GSM modules, a channel measurer 213 for measuring the signal strengths of the channels designated to the first GSM module, a measurement collector 215 for collecting the measurements values of the channels measured by the first and second GSM modules, and a channel arranger 217 for arranging the channels in the order of the signal strengths of the channels. The second channel measurement unit 230 is provided with a channel index manager 231 for managing the channel indexes of the channels designated for the second GSM module and a channel measurer 233 for measuring the signal strengths of the channels designated for the second GSM module. Although the first and second channel measurement units 210 and 230 are independently implemented in this embodiment, they can be integrated into the respective control units 430 and 440. In this case, the first and second channel measurement units 210 and 230 are omitted in the configuration of the mobile terminal of FIG. 4.

Although the display unit 435 and the input unit 437 are connected to the first control unit 430 of the first GSM module in FIG. 4, the display unit 435 and the input unit 437 can be configured so as to be shared by the first and second GSM modules. Also, the first and second storage units 431 and 441 can be implemented as a single storage unit physically.

The display unit 435 receives video data supplied by the first and second control units 430 and 440 and displays the video data in the form of visual image. The display unit 435 also can display various information such as communication-related information, incoming and outgoing call information, phonebook data, incoming call alert message, operation status of the mobile terminal, and the like. The display unit 435 also can display the manipulation and operation information of the mobile terminal 400, application program execution status and execution result. The display unit 435 can be implemented with various display devices such as Liquid Crystal Display (LCD) and Organic Light Emitting Diodes (OLED).

The input unit 437 generates command signals for controlling the operations of the mobile terminal 400. The input unit 437 can be implemented with at least one of keypad, touchscreen, and touchpad.

The first and second storage units 431 and 441 store the application programs required for executing various functions of the mobile terminal and data generated while executing the functions and input by the user under the control of the first and second control unit 430 and 440.

In addition to the internal elements depicted in FIG. 4, the dual band dual standby mobile terminal may include at least one of a camera module, a short range communication module such as Bluetooth, a connection port for supporting data communication with an external device, a power charging port, a battery, at least one Power Management Unit (PMU), an audio playback module such as MP3 module, and audio processing unit for processing audio signal including voice.

As described above, the channel measurement method and apparatus for a multi-band multi-standby mobile terminal enables at least two communication modules to perform channel measurement on the channels that are fairly designated, thereby reducing the time taken for measuring the total number of channels. By reducing the initialization procedure of the mobile terminal with the reduced channel measure time, the mobile terminal can quickly camp on a serving cell even when the mobile terminal is in a limited switched virtual circuit (SVC) session. Since the number of channels designated to be measured by each GSM module is reduced as much as 1/N (N is the number of GSM modules), the time taken for measuring the channels also decreases 1/N, resulting in reduction of power consumption.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A channel measurement method for a multi-band mobile terminal, comprising:
measuring, at a first module and a second module, signal strengths on channels designated for the first and second modules;
collecting the signal strengths of the channels measured by the first and second modules; and
arranging the channels in an order of the signal strengths.

2. The channel measurement method of claim 1, further comprising designating the channels for the first and second modules according to predetermined channel designation criteria.

3. The channel measurement method of claim 2, wherein designating the channels comprising designating half of total channels for the first module and designating the other half of the total channels for the second module.

4. The channel measurement method of claim 2, wherein designating the channels comprising designating different numbers of the channels for the first and second modules.

5. The channel measurement method of claim 2, wherein measuring signal strengths comprises:
managing, at the second module, channel indexes of the channels designated for the second module; and
measuring the signal strengths of the channels indicated by the channel indexes.

6. A channel measurement method for a multi-band multi-standby mobile terminal, comprising:
designating, by a channel designator, channels for a master module and at least one slave module according to predetermined channel designation criteria;
measuring, by channel measurement units of the modules, signal strengths of the channels designated by the channel designator;
collecting, by a measurement collector, the signal strengths of the designated channels measured by the channel measurement units; and
arranging, by a channel arrangement unit, the channels in an order of the signal strengths.

7. The channel measurement method of claim 6, wherein the channel designation criteria is determined according to performances of the master and slave modules.

8. The channel measurement method of claim 7, wherein designating channels comprises designating half of total channels for the master module and designating the other half of the total channels for the at least one slave module.

9. The channel measurement method of claim 7, wherein designating the channels comprising designating different numbers of the channels for the master and at least one slave modules.

10. The channel measurement method of claim 7, wherein measuring signal strengths comprises:
managing, at the slave module, channel indexes of the channels designated for the at least one slave module; and
measuring the signal strengths of the channels indicated by the channel indexes.

11. A channel measurement apparatus for a multi-band mobile terminal, comprising:
a master module for designating channels for at least one module, measuring signal strengths designated for itself, collecting the signal strengths, and arranging the channels in an order of the signal strengths; and
at least one slave module for measuring signal strengths of the channel designated by the master module and transmitting the measured signal strengths to the master module.

12. The channel measurement apparatus of claim 11, wherein the master module comprises:
a channel designator for designating predetermined numbers of channels for the master and slave modules;
a channel measurer for measuring the signal strengths of the channels designated for the master module;
a measurement collector for collecting the signal strengths of the channels measured by the master and slave modules; and
a channel arranger for arranging the channels in an order of the signal strengths.

13. The channel measurement apparatus of claim 12, wherein the channel designator designates the channels for the master and slave modules on the basis of channel designation criteria.

14. The channel measurement apparatus of claim 13, wherein the channel designation criteria are predetermined according to performances of the master and slave modules.

15. The channel measurement apparatus of claim 14, wherein the master and slave modules are designated the same number of channels indicated by different channel indexes.

16. The channel measurement apparatus of claim 14, wherein the master and slave modules are designated different numbers of channels indicated by different channel indexes.

17. The channel measurement apparatus of claim 12, wherein the at least one slave module comprises:
a channel index manager for managing the channel indexes of the channels designated for the at least one slave module; and
a channel measurer for measuring the signal strengths of the channels indicated by the channel indexes.
